(19) United States
(12) Patent Application Publication
(10) Pub. No.: US 2013/0280647 A1
(43) Pub. Date: Oct. 24, 2013

(54) CROSS-LINKED CHARGE TRANSPORT MATERIALS MADE BY LOW ENERGY HYDROGEN BOMBARDMENT

(71) Applicants: Yu LIU, Mississauga (CA); Yiliang Wu, Oakville (CA); Nan-Xing Hu, Oakville (CA); Gregory M. McGuire, Oakville (CA); Richard A. Klenkler, Oakville (CA); Vladislav Skorokhod, Mississauga (CA); Johann Junginger, Toronto (CA)

(72) Inventors: Yu LIU, Mississauga (CA); Yiliang Wu, Oakville (CA); Nan-Xing Hu, Oakville (CA); Gregory M. McGuire, Oakville (CA); Richard A. Klenkler, Oakville (CA); Vladislav Skorokhod, Mississauga (CA); Johann Junginger, Toronto (CA)

(73) Assignee: Xerox Corporation, Norwalk, CT (US)

(21) Appl. No.: 13/454,195

(22) Filed: Apr. 24, 2012

(51) Int. Cl. G03G 15/00; G03G 5/07; G03G 5/06

(52) U.S. Cl. 430/56; 399/159; 430/66; 430/127

(57) ABSTRACT

This application discloses a photoreceptor comprising a surface layer that is comprised of an organic composition cured by neutral molecular hydrogen bombardment. Methods for forming a photoreceptor having a cured surface are disclosed.

### BACKGROUND

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment moves under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

Electrophotographic imaging members, e.g., photoreceptors, photoconductors, and the like, include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

Multilayered photoreceptors or imaging members have at least two layers, and may include a substrate, a conductive layer, an optional undercoat layer (sometimes referred to as a “charge blocking layer” or “hole blocking layer”), an optional adhesive layer, a photogenerating layer (sometimes referred to as a “charge generation layer,” “charge generating layer,” or “charge generator layer”), a charge transport layer, and an optional overcoating layer in either a flexible belt form or a rigid drum configuration. In the multilayer configuration, the active layers of the photoreceptor are the charge generation layer (CGL) and the charge transport layer (CTL). Enhancement of charge transport across these layers provides better photoreceptor performance. Multilayered flexible photoreceptor members may include an anti-curl layer on the backside of the substrate, opposite to the side of the electrically active layers, to render the desired photoreceptor flatness.

Organic photoreceptors have been widely applied in major production lines of xerographic machines in view of their low cost and environment friendliness. However, after being repeatedly cycled in an image forming apparatus, undesirable abrasion and scratching of the photoreceptor, due to its exposure to electrical stress, mechanical stress, and ozone or nitrogen oxide, degrades the predetermined sensitivity, electrical and photo properties, thus limiting its service life.

Enhanced stiffness of photoreceptor surface (e.g., crosslinked surface layer) can improve the wear resistance, thus resulting in a longer photoreceptor life. Conventional approaches to achieve crosslinked structures include chemical polymerizations of reactive resins (such as melamine resins) and irradiation induced polymerization such as UV, plasma, or e-beam. Chemical polymerizations typically require catalysts or initiators to facilitate the crosslinking, which would be harmful for electrical properties of photoreceptor. Irradiation-based techniques have been used, however, these approaches often require higher-energy carriers, such as e-beams or ionized gases, that inevitably alter chemical properties of the photoreceptor and damage the electrical performance.

There remains a need for a universal and gentle method to stiffen the surfaces of photoreceptors without deteriorating photoreceptor electrical performance and/or altering photoreceptor morphology.

### SUMMARY

The present disclosure relates to methods of applying neutral molecular hydrogen, H₂, carrying low kinetic energy to treat one or more layers of photoreceptor. The methods disclosed herein may be use to stiffen the active layer(s) or surface layer of photoreceptor, for example, the charge transport layer. The treated photoreceptor layer(s) (e.g., charge transport layer) have enhanced stiffness, while maintaining good electrical properties. Furthermore, the treatment methods do not produce major changes in surface morphology.

According to some embodiments, methods are provided for stiffening the surface of an organic photoreceptor comprising applying low-energy (e.g., from about 10 to 20 eV) neutral molecular hydrogen, H₂, to treat the photoreceptor surface. The methods of the present disclosure allow selective targeting on C—H bonds with other chemical bonds kept intact to generate free radicals to produce a crosslinked surface without deteriorating photoreceptor electrical performance. The treatment produces a hardened cross-linked surface layer(s) with minimal impact on electrical discharge performance as well as the morphology of the photoreceptor.

In some embodiments, methods are provided comprising applying neutral hydrogen molecules carrying low kinetic energy to treat the electrically active layer(s) of photoreceptor. The treatment produces a hardened cross-linked electrically active layer(s) with minimal impact on electrical discharge performance as well as the morphology of the photoreceptor. The active layers of the photoreceptor include the charge generation layer (CGL) and the charge transport layer (CTL).

In some embodiments, methods are provided comprising applying neutral hydrogen molecules carrying low kinetic energy to treat one or more layers of a multilayered photoreceptor (or imaging member), wherein the one or more layers of a multilayered photoreceptor is selected from the group consisting of a substrate layer, a conductive layer, an undercoat layer, an adhesive layer, a charge generation layer, a charge transport layer, and an overcoating layer.

Presently disclosed embodiments relate to an improved electrophotographic imaging member or photoreceptor comprising a surface layer on the photoreceptor, where the surface layer comprising materials are treated with low-energy neutral hydrogen bombardment.

According to some embodiments, a photoreceptor is provided, said photoreceptor comprising a surface layer, wherein said surface layer is comprised of an organic composition cured by neutral hydrogen bombardment. The stiffness of the surface layer may be at least 60,000 N/m. The neutral hydrogen bombardment may comprise a molecular hydrogen having kinetic energy of from about 5 eV to about 100 eV.

In some embodiments, the photoreceptor having the cured surface layer displays electrical properties that are at least 90% equivalent to a photoreceptor having a surface layer untreated with neutral hydrogen bombardment, wherein the electrical properties include charge acceptance, dark decay, V_{low} and photosensitivity.

In some embodiments, the organic composition comprises an organic material containing a hydrogen-carbon bond. In some embodiments, the organic composition contains a photoconductive component. In some embodiments, the organic composition comprises an organic material selected from the group consisting of a charge transport molecule, a polymer, and the mixture thereof. In some embodiments, the charge transport molecule comprises a tertiary arylamine. In some embodiments, the surface layer is part of a charge transport layer comprising a charge transport molecule and a polymer. In some embodiments, the surface layer is an overcoat layer. In some embodiments, the overcoat layer is a separate organic coating disposed on a charge transport layer. In some embodiments, the photoreceptor further comprises a charge generating layer.

In some embodiments, the surface layer has a thickness ranging from about 1 micron to about 30 microns (e.g., about 1 micron to about 10 microns). In some embodiments, the surface layer has a thickness ranging from about 0.1 micron to about 1 micron (e.g., about 0.5 micron to about 1 micron).

According to some embodiments, a method for forming a photoreceptor having a cured surface is provided, said method comprising: providing a photoreceptor member whose surface layer comprises an organic composition containing C—H bond; providing neutral hydrogen bombardment sources; and exposing the surface of the photoreceptor to the hydrogen species to form a crosslinked surface through reaction of the C—H bonds in the organic material. The hydrogen species may comprise neutral hydrogen molecules with kinetic energy from about 5 eV to about 100 eV. The fluence of hydrogen species may be about 3×10¹⁵ to about 1×10¹⁷ molecules per cm². In some embodiments, the organic composition comprises a material selected from the group consisting of a charge transport molecule, a charge generating material, a polymer, and the mixture thereof.

In some embodiments, the effective depth of hydrogen bombardment is about 1 micron to about 30 microns (e.g., about 1 micron to about 10 microns). In some embodiments, the effective depth of hydrogen bombardment is about 0.1 micron to about 1 micron (e.g., about 0.5 micron to about 1 micron).

According to some embodiments, an image forming apparatus is provided, said apparatus comprising: a multilayered photoreceptor; a charging unit that electrically charges the surface of the photoreceptor; an exposing unit that exposes the surface of the photoreceptor electrically charged by the charging unit to form an electrostatic latent image; a developing unit that develops the electrostatic latent image using a developer containing at least toner to form a toner image; and a transferring unit that transfers the toner image onto a recording medium, wherein said multilayered photoreceptor comprises one or more photoconductive layers, wherein at least one photoconductive layer comprises an organic material cured with low-energy neutral hydrogen bombardment from about 5 eV to about 100 eV. In some embodiments, the at least one photoconductive layer is a charge transport layer. In some embodiments, the at least one photoconductive layer is an overcoat layer. In some embodiments, the photoreceptor possesses a residual potential increase less than about 5 V after 10000 cycle of continued running.

According to some embodiments, an image forming apparatus is provided, said apparatus comprising photoreceptor according to the present embodiments.

According to some embodiments, a photoreceptor is provided, said photoreceptor comprising a surface layer, wherein the stiffness of the surface layer is at least 60,000 N/m.

### BRIEF DESCRIPTION OF THE DRAWINGS

FIG. 1. Illustration of hydrogen collision-induced C—H dissociation for surface crosslinking.

FIGS. 2A and 2B. Static force (A) to displacement curves and stiffness (B) to displacement curves of charge transport layer of photoreceptor surfaces before and after treatment by hydrogen bombardment.

FIGS. 3A and 3B. Dissolubility of untreated photoreceptor surface (A) and treated photoreceptor surface (B) in hexane.

FIG. 4. Electrical properties of untreated and treated photoreceptor.

FIGS. 5A and 5B. Printing tests of treated (A) and untreated (B) photoreceptor.

FIGS. 6A to 6C. Atomic Force Microscopy (AFM) images on morphology of (A) untreated photoreceptor surface and (B and C) plasma treated photoreceptor surface at 5.9 nm; 14.3 nm (B: plasma fluence of 10¹⁴ ions/cm²); and 42.7 nm (C: plasma fluence of 10¹⁵ ions/cm²). B and C are treated at different fluence, see Qureshi A., et al., J. Phys., 2010.

FIGS. 7A and 7B. AFM images on morphology of untreated photoreceptor surface (A; ˜0.198 nm) and Hydrogen Bombardment treated photoreceptor surface (B; ˜0.186 nm).

FIG. 8. Provides a cross-sectional view of a multilayered photoreceptor in a drum configuration.

FIG. 9. Provides a cross-sectional view of a multilayered photoreceptor in a belt configuration.

### DETAILED DESCRIPTION

### Definitions

Unless otherwise defined, all technical and scientific terms used herein have the same meaning as commonly understood by one of ordinary skill in the art.

As used herein, “one or more layers of a photoreceptor” refers to one or more (e.g., 1, 2, 3, 4, 5, 6, 7, or more) layers, including optional layers, of a multilayered photoreceptor, including, but not limited to, a photosensitive layer, an electrically active layer, a substrate layer, a conductive layer, an undercoat layer (a.ka., “charge blocking layer” or “hole blocking layer”), an adhesive layer, a photogenerating layer (a.k.a. “charge generation layer,” “charge generating layer,” or “charge generator layer”), a charge transport layer, and an overcoating layer.

The “photosensitive layer” referred to herein may be a functionally-integrated photosensitive layer having both a charge transporting function and a charge generating function, or may be a functionally-separated photosensitive layer having a charge transport layer or a charge generation layer. Further, if necessary, other layers such as an undercoat layer, an intermediate layer, an overcoat layer and the like may be provided to the photoreceptor.

The term “cured” is meant to refer specifically to the material in a crosslinked condition or the chemical connection of adjacent linear polymer chains by means of a crosslinking species (e.g., neutral hydrogen). The density of crosslinking of the polymer can, of course, vary, which is intended to refer to the number of monomer units in the polymer from which crosslinks originate in relation to the total number of monomer units.

The term “curable” refers, for example, to the component or combination being polymerizable, that is, a material that may be cured via polymerization, including for example free radical routes.

The term “radiation curable” is intended to cover all forms of curing upon exposure to a radiation source, including light and heat sources and including in the presence or absence of initiators. Example radiation curing routes include, but are not limited to, curing using ultraviolet (UV) light, for example having a wavelength of 200-400 nm or more rarely visible light, such as in the presence of photoinitiators and/or sensitizers, curing using e-beam radiation, such as in the absence of photoinitiators, curing using thermal curing, in the presence or absence of high temperature thermal initiators (and which are generally largely inactive at the jetting temperature), and appropriate combinations thereof. By way of example, a surface layer of the present embodiments may be 1) cured by neutral hydrogen bombardment, 2) radiation cured and then cured by neutral hydrogen bombardment, or vice versa, or 3) simultaneously radiation cured and cured by neutral hydrogen bombardment.

For the purposes of promoting an understanding of the embodiments described herein, reference will be made to certain embodiments and specific language will be used to describe the same. The terminology used herein is for the purpose of describing particular embodiments only, and is not intended to limit the scope of the present embodiments. As used throughout this disclosure, the singular forms “a,” “an,” and “the” include plural reference unless the context clearly dictates otherwise. Thus, for example, a reference to “a composition” includes a plurality of such compositions, as well as a single composition.

### Surface Treatment by Hydrogen Bombardment

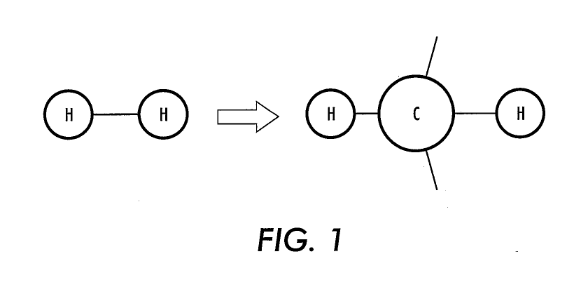

The physical principle of low-energy hydrogen bombardment is demonstrated in FIG. 1. When the molecular axis of molecular hydrogen H₂ carrying certain kinetic energies is making head-on collision with target chemical bonds, its energy can be effectively transferred to the target. In some embodiments, the kinetic energies of the projectile particles can be less than about 150 eV. For example, in some embodiments, the kinetic energies of the projectile particles are between about 4 eV to about 100 eV, including between about 5 eV to about 80 eV, between about 5 eV to about 50 eV, about 10 eV and about 30 eV, and about 10 eV and about 20 eV.

According to some embodiments, methods are provided for making a photoreceptor or one or more layers of a photoreceptor (e.g., surface layer) using the low-energy hydrogen bombardment process of the present embodiments. In some embodiments, the low-energy hydrogen bombardment process comprises: (a) providing a substrate; (b) bombarding the substrate with hydrogen projectile particles which have kinetic energies between about 4 eV and about 30 eV. The hydrogen bombardment process promotes cross-linking of the polymeric materials present in the one or more layers of a photoreceptor. In this regard, one or more layers of the photoreceptor may be made with a reduced concentration or without catalysts or initiators to facilitate the crosslinking of the polymeric materials used to form photoreceptor layers.

In some embodiments, the substrate is one or more layers of a photoreceptor, such as a surface layer, a photosensitive layer, an electrically active layer, a charge generating layer, or a charge transport layer of a photoreceptor.

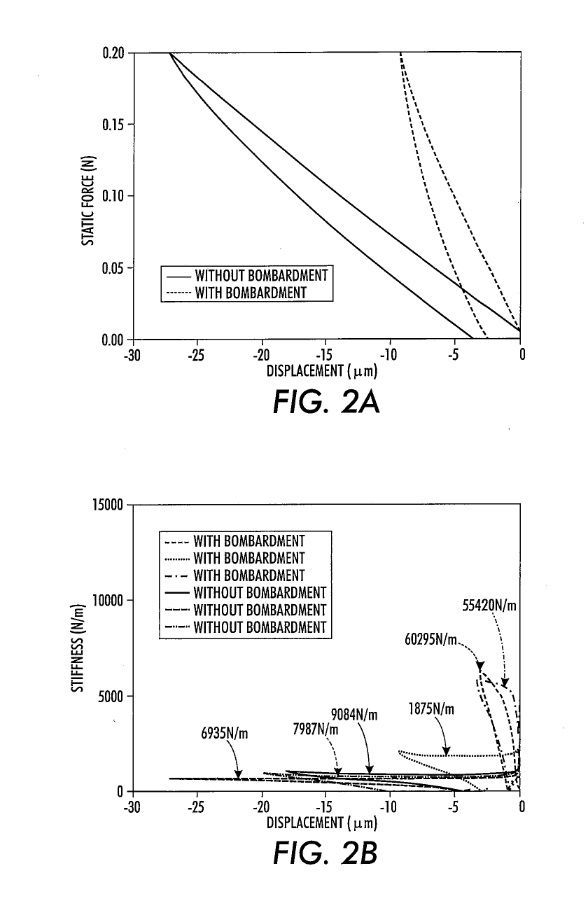

In some embodiments, the one or more layers of a photoreceptor treated using the methods of the present embodiments display a stiffness that is enhanced by about 1.5 to about 30 times compared to untreated substrate, which includes about 5 to about 15 times, about 9 to about 20 times, and about 10 to about 30 times. For example, the stiffness was increased from about 6935 N/m to 60,295 N/m as shown in FIG. 2B.

In some embodiments, the substrate layer (e.g. surface layer) of a photoreceptor treated using the methods of the present embodiments displays a stiffness from about 60,000 N/m to about 120,000 N/m, from about 60,000 N/m to about 100,000 N/m, from about 60,000 N/m to about 80,000 N/m, or from about 60,000 N/m to about 70,000 N/m.

In some embodiments, the one or more layers of a photoreceptor treated using the methods of the present embodiments display a morphology that is at least 90% (e.g., 95%, 97%, 98%, etc.) equivalent to untreated substrate.

In some embodiments, photoreceptors having the one or more layers treated using the methods of the present embodiments display electrical properties that are at least 90% (e.g., 95%, 97%, 98%, etc.) equivalent to a like photoreceptor having untreated substrate. Relative electrical properties should be compared using the same printer and photoreceptor combination or system to control for variables such as printing speed and photoreceptor size. This is because in a print engine, the photoreceptor, developer and toner, light exposure system, motors and timings are all designed to work together as a system.

Relevant electrical properties include Charge Acceptance, Dark Decay, V_{low} and Photosensitivity. Charge Acceptance refers to the surface voltage relative to applied voltage. Dark Decay refers to the surface voltage drop in the absence of light and in the absence of applied voltage. For example, the photoreceptor charged to a certain voltage at a start point of each cycle will decrease until the same start point of the next cycle. Photosensitivity refers to the surface voltage drop relative to light exposure energy. The photosensitivity of an imaging member is usually provided in terms of the initial slope of the photoinduced discharge curve (PIDC), where a higher slope is preferred. Vlow refers to the voltage after light exposure.

In some embodiments, photoreceptors having the one or more layers treated using the methods of the present embodiments display image quality that is at least 90% (e.g., 95%, 97%, 98%, etc.) equivalent to a like photoreceptor having untreated substrate.

In another embodiment, a hydrocarbon film dense enough to provide a protective layer on the surface layer of the photoreceptor can be produced using the low-energy hydrogen bombardment process. For example, a surface layer of photoreceptor is treated with the low-energy hydrogen bombardment process in a method comprising bombarding the surface layer with hydrogen projectile particles which have kinetic energies between about 4 eV and about 30 eV for a period sufficient to form a hardened film on the surface of the photoreceptor.

In some embodiments, methods are provided comprising applying neutral molecular hydrogen, H₂, carrying low kinetic energy to treat the charge transport layer (CTL) of photoreceptor and therefore introduce cross-linking in the charge transport layer. In embodiments, the treatment produces a hardened cross-linked charge transport layer with minimal impact on electrical discharge performance as well as the morphology of the photoreceptor.

In some embodiments, the proton projectile particles are generated using an electron cyclotron resonance (ECR) plasma reactor or other plasma reactors. The proton projectile particles can be generated using any suitable apparatus or process. In some embodiments, the velocities of the particles can be increased by ionizing them and then accelerating them in an electrostatic ionization process. In this regard, the ionized particles may form an ion beam. Generating ionized projectile particles and ion beams is well known. An exemplary apparatus that can be used to generate a beam of ionized projectile particles may be an electron cyclotron resonance (ECR) plasma reactor. Electron cyclotron resonance plasma reactors are widely used for reactive ion etching in the semiconductor industry because they can generate intense beams of energetic particles. Such reactors are commercially available.

In a typical embodiment, the layer or material to be treated is placed in a chamber in a bombardment apparatus. Hydrogen projectiles are created upstream of the substrate and bombard the layer or material with hydrogen-containing molecules. After bombardment, the layer or material is removed from the chamber.

In some embodiments, an electron-cyclotron-resonance (ECR) microwave plasma may be utilized to generate an intense beam of proton projectiles carrying kinetic energy, and these projectiles are used to initiate a cascade of collision with H₂ molecules in a drift zone, which is filled with hydrogen gas. The initial kinetic energy of the proton is therefore transferred to the neutral H₂ molecules via a cascade of collision in the drift zone, producing an intense beam of neutral hydrogen carrying specific energy. Finally, these neutral H₂ molecules are projected onto the sample surface. According to the first-approximation of hard-sphere binary collision, when a projectile collides head-on with a target, its energy can be most effectively transferred. The energy Et transferred on the target molecule can be determined by:

$${E}_{t} = \frac{4 {M}_{t} {M}_{p}}{{( {M}_{t} + {M}_{p} )}^{2}} {E}_{p}$$

Present hydrogen bombardment process had been designed to generate H₂ projectiles with low kinetic energy (e.g., ˜10 eV for individual molecule). Based on Table 1, the effective energy transferred to a C—H bond, after collision between a molecular hydrogen with kinetic energy 10 eV and a hydrogen atom of a C—H bond, is less than about 20 eV completely, such as less than about 1 e, about 5 eV or about 10 eV completely. It could effectively break a C—H bond with bond energy only 4.3 eV as shown in Table 2. However, if the collision happens between hydrogen and a carbon atom, only 2.8 eV is effectively transferred and could not break a C—C bond.

TABLE I
Maximum energy transferred from projectiles to target atoms.

| | Atom-atom | | | | | |
|---|---|---|---|---|---|---|
| | 10 eV | 10 eV | 5 eV | 5 eV | 15 eV | 15 eV |
| interaction | H → H | H → C | H → H | H → C | H → H | H → C |
| Transferred | 10 | 2.8 | 5 | 1.4 | 15 | 4.3 |
| energy (eV) | | | | | | |

TABLE II
Bond energy for typical chemical bonds.

| | Chemical bond | | |
|---|---|---|---|
| | C—H | C—C | C═C (π bond) |
| Bond energy (eV) | 4.3 | 3.6 | 2.7 |

The number of ions or density of ions used to bombard the hydrogen containing molecules can vary according to the particular molecules that are to be bombarded.

The fluences used for the hydrogen bombardment process may be between about 1×10¹³ ions/cm² to 1×10²⁰ ions/cm², including about 1×10¹⁶ ions/cm² to about 1×10¹⁸ ions/cm², about 1×10¹⁶ ions/cm² to about 1×10¹⁷ ions/cm², and about 1×10¹⁵ ions/cm² to about 1×10¹⁷ ions/cm². For example, the fluence for about 10 eV to about 20 eV may be about 1×10¹⁶ ions/cm² to about 1×10¹⁷ ions/cm² (e.g., about 2×10¹⁶, 3×10¹⁶, 4×10¹⁶, 5×10¹⁶, 6×10¹⁶, 7×10¹⁶, 8×10¹⁶, 9×10¹⁶ ions/cm²).

### Photoreceptor

According to some embodiments, there is provided a photoreceptor having a surface layer, wherein the surface layer comprises material treated with the low-energy neutral hydrogen bombardment process of the present embodiments. In some embodiments, the surface layer is a charge transport layer. In some embodiments, the surface layer is disposed over a charge transport layer. In some embodiments, the surface layer is an overcoat layer. In some embodiments, the surface layer is a protective surface layer and the photoreceptor further comprises an overcoat layer disposed between the charge transport layer and the protective surface layer.

According to some embodiments, there is provided a multilayered organic photoreceptor comprising one or more electrically active layers, wherein at least one electrically active layer comprises material treated with the low-energy hydrogen bombardment process of the present embodiments. In some embodiments, at least one electrically active layer is a charge generation layer. In some embodiments, at least one electrically active layer is a charge transport layer.

### Surface Layer

The surface layer of the present embodiments may be presented in numerous configurations so long as the layer comprises a surface portion of the photoreceptor. For example, in embodiments, the surface layer may be a charge transport layer or be a separate layer disposed on top of the charge transport layer. In other embodiments, where the photoreceptor comprises an overcoat layer, the surface layer may be the overcoat layer or be a separate layer disposed on top of the overcoat layer. In further embodiments, where the photoreceptor comprises a single layer disposed on the substrate, the surface layer may be that single layer or be a separate layer disposed on top of the single layer.

### Image Forming Apparatus

According to some embodiments, there is provided an image forming apparatus for forming images on a recording medium comprising a photoreceptor having a surface layer, wherein the surface layer comprises material treated with the low-energy neutral hydrogen bombardment process of the present embodiments.

There is provided an image forming apparatus for forming images on a recording medium comprising a multilayered organic photoreceptor comprising one or more electrically active layers, wherein at least one electrically active layer comprises material treated with the low-energy hydrogen bombardment process of the present embodiments. In some embodiments, at least one electrically active layer is a charge generation layer. In some embodiments, at least one electrically active layer is a charge transport layer.

According to some embodiments, there is provided an image forming apparatus for forming images on a recording medium comprising (a) a photoreceptor having a charge retentive-surface for receiving an electrostatic latent image thereon, wherein the photoreceptor comprises a substrate, an optional undercoat layer disposed on the substrate, a charge generation layer disposed on the undercoat layer, a charge transport layer disposed on the charge generation layer, and a surface layer disposed on the charge transport layer, wherein the surface layer of the photoreceptor comprises a material treated with the low-energy neutral hydrogen bombardment process of the present embodiments; (b) a development component for applying a developer material to the charge-retentive surface to develop the electrostatic latent image to form a developed image on the charge-retentive surface; (c) a transfer component for transferring the developed image from the charge-retentive surface to a copy substrate; and (d) a fusing component for fusing the developed image to the copy substrate.

### Multilayered Photoreceptors

Multilayered photoreceptors or imaging members may include one or more of the following treatable layers: a substrate layer, a conductive layer, an undercoat layer (a.k.a., “charge blocking layer” or “hole blocking layer”), an adhesive layer, a photogenerating layer (a.k.a. “charge generation layer,” “charge generating layer,” or “charge generator layer”), a charge transport layer, and an overcoating layer in either a flexible belt form or a rigid drum configuration. Multilayered flexible photoreceptor members may include an anti-curl layer on the backside of the substrate, opposite to the side of the electrically active layers, to render the desired photoreceptor flatness.

In some embodiments, the electrically active layers of the photoreceptor may be treated according to the methods disclosed herein. The active layers of the photoreceptor include the charge generation layer (CGL) and the charge transport layer (CTL).

The exemplary embodiments of this disclosure are described below with reference to the drawings. The specific terms are used in the following description for clarity, selected for illustration in the drawings and not to define or limit the scope of the disclosure. The same reference numerals are used to identify the same structure in different figures unless specified otherwise. The structures in the figures are not drawn according to their relative proportions and the drawings should not be interpreted as limiting the disclosure in size, relative size, or location. In addition, though the discussion will address negatively charged systems, the imaging members of the present disclosure may also be used in positively charged systems.

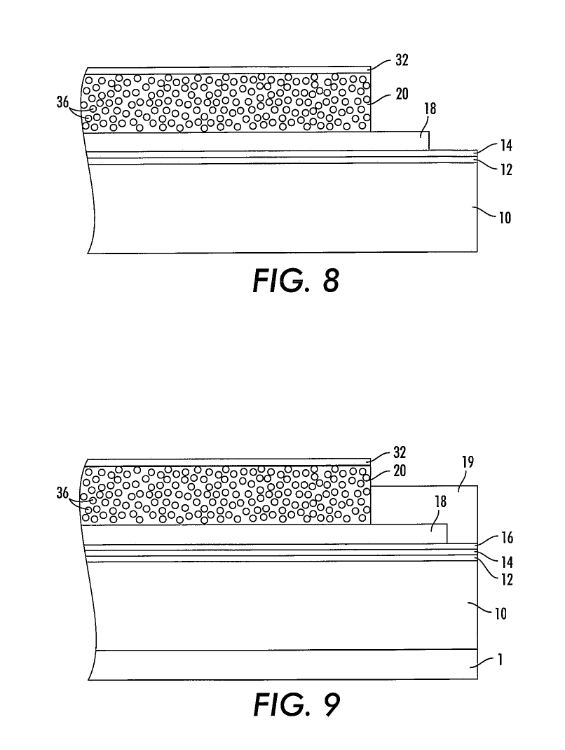

FIG. 8 is an exemplary embodiment of a multilayered electrophotographic imaging member having a drum configuration. As can be seen, the exemplary imaging member includes a rigid support substrate 10, an undercoat layer 14, a charge generation layer 18 and a charge transport layer 20. The rigid substrate may be comprised of a material selected from the group consisting of a metal, metal alloy, aluminum, zirconium, niobium, tantalum, vanadium, hafnium, titanium, nickel, stainless steel, chromium, tungsten, molybdenum, and mixtures thereof. The charge generation layer 18 and the charge transport layer 20 form an imaging layer described here as two separate layers. In an alternative to what is shown in the figure, the charge generation layer may also be disposed on top of the charge transport layer. It will be appreciated that the functional components of these layers may alternatively be combined into a single layer. The photosensitive layer(s) may further comprise compound(s) 36 to promote increased photosensitivity.

### The Charge Transport Layer

In a drum photoreceptor, the charge transport layer comprises a single layer of the same composition. As such, the charge transport layer will be discussed specifically in terms of a single layer 20, but the details will be also applicable to an embodiment having dual charge transport layers. The charge transport layer 20 is thereafter applied over the charge generation layer 18 and may include any suitable transparent organic polymer or non-polymeric material capable of supporting the injection of photogenerated holes or electrons from the charge generation layer 18 and capable of allowing the transport of these holes/electrons through the charge transport layer to selectively discharge the surface charge on the imaging member surface. In one embodiment, the charge transport layer 20 not only serves to transport holes, but also protects the charge generation layer 18 from abrasion or chemical attack and may therefore extend the service life of the imaging member. The charge transport layer 20 can be a substantially non-photoconductive material, but one which supports the injection of photogenerated holes from the charge generation layer 18.

FIG. 9 shows an imaging member having a belt configuration according to the embodiments. As shown, the belt configuration is provided with an anti-curl back coating 1, a supporting substrate 10, an electrically conductive ground plane 12, an undercoat layer 14, an adhesive layer 16, a charge generation layer 18, and a charge transport layer 20. An optional overcoat layer 32 and ground strip 19 may also be included. An exemplary photoreceptor having a belt configuration is disclosed in U.S. Pat. No. 5,069,993, which is hereby incorporated by reference. In embodiments, the charge transport layer is treated according to the present embodiments.

The charge transport layer may comprise a film forming polymer material selected from the group consisting of at least one of polycarbonates, polystyrenes, polyarylates, polyesters, polyimides, polysiloxanes, polysulfones, polyphenyl sulfides, polyetherimides, and polyphenylene vinylenes. In more specific embodiments, the polymer comprises a film forming polymer material selected from the group consisting of poly(bisphenol-A carbonate), poly(bisphenol-Z carbonate), poly(bisphenol-A carbonate)-co-poly(bisphenol-Z carbonate).

In embodiments, the acid polymer is a vinyl chloride/vinyl acetate/maleic acid terpolymer. In this embodiment, the vinyl chloride monomer is present in the polymer in any desired or effective amount, in one embodiment at least about 50 percent by weight, in another embodiment at least about 70 percent by weight, and in yet another embodiment at least about 80 percent by weight, and in one embodiment no more than about 90 percent by weight, although the amount can be outside of these ranges. The vinyl acetate monomer is present in the polymer in any desired or effective amount, in one embodiment at least about 5 percent by weight, and in another embodiment at least about 10 percent by weight, and in one embodiment no more than about 25 percent by weight, in another embodiment no more than about 20 percent by weight, and in yet another embodiment no more than about 15 percent by weight, although the amount can be outside of these ranges. The maleic acid monomer is present in the polymer in any desired or effective amount, in one embodiment at least about 0.2 percent by weight, and in another embodiment at least about 0.5 percent by weight, and in one embodiment no more than about 5 percent by weight, in another embodiment no more than about 2 percent by weight, and in yet another embodiment no more than about 1.5 percent by weight, although the amount can be outside of these ranges.

Examples of suitable acid polymers include VMCH, available from Dow Chemical Co., Midland, Mich., having about 86 percent by weight vinyl chloride, about 13 percent by weight vinyl acetate, and about 1 percent by weight maleic acid, and a number average molecular weight of about 27,000, UCAR® VMCH, available from Union Carbide Corporation, Danbury, Conn., having about 86 percent by weight vinyl chloride, about 13 percent by weight vinyl acetate, and about 1 percent by weight maleic acid, UCAR® YMCA, available from Union Carbide Corporation, having about 86 percent by weight vinyl chloride, about 13 percent by weight vinyl acetate, and about 1 percent by weight maleic acid, UCAR® YMCA, available from Union Carbide Corporation, having about 81 percent by weight vinyl chloride, about 17 percent by weight vinyl acetate, and about 2 percent by weight maleic acid, and the like, as well as mixtures thereof.

The layer 20 is normally transparent in a wavelength region in which the electrophotographic imaging member is to be used when exposure is affected there to ensure that most of the incident radiation is utilized by the underlying charge generation layer 18. The charge transport layer should exhibit excellent optical transparency with negligible light absorption and no charge generation when exposed to a wavelength of light useful in xerography, e.g., 400 to 900 nanometers. In the case when the photoreceptor is prepared with the use of a transparent substrate 10 and also a transparent or partially transparent conductive layer 12, image wise exposure or erase may be accomplished through the substrate 10 with all light passing through the back side of the substrate. In this case, the materials of the layer 20 need not transmit light in the wavelength region of use if the charge generation layer 18 is sandwiched between the substrate and the charge transport layer 20. The charge transport layer 20 in conjunction with the charge generation layer 18 is an insulator to the extent that an electrostatic charge placed on the charge transport layer is not conducted in the absence of illumination. The charge transport layer 20 should trap minimal charges as the charge passes through it during the discharging process.

The charge transport layer 20 may include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes through. This addition converts the electrically inactive polymeric material to a material capable of supporting the injection of photogenerated holes from the charge generation layer 18 and capable of allowing the transport of these holes through the charge transport layer 20 in order to discharge the surface charge on the charge transport layer. The high mobility charge transport component may comprise small molecules of an organic compound which cooperate to transport charge between molecules and ultimately to the surface of the charge transport layer.

The charge transport material is present in the charge transport layer in any desired or effective amount, in one embodiment at least about 5 percent by weight, in another embodiment at least about 20 percent by weight, and in yet another embodiment at least about 30 percent by weight, and in one embodiment no more than about 90 percent by weight, in another embodiment no more than about 75 percent by weight, and in another embodiment no more than about 60 percent by weight, although the amount can be outside of these ranges.

A number of charge transport compounds can be included in the charge transport layer, which layer generally is of a thickness of from about 5 to about 75 micrometers, and more specifically, of a thickness of from about 15 to about 40 micrometers. Examples of charge transport components are aryl amines of the following formulas/structures:

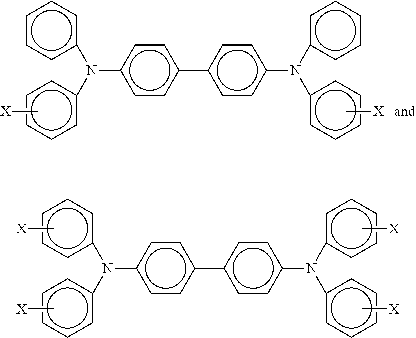

wherein X is a suitable hydrocarbon like alkyl, alkoxy, aryl, and derivatives thereof; a halogen, or mixtures thereof, and especially those substituents selected from the group consisting of Cl and CH₃; and molecules of the following formulas;

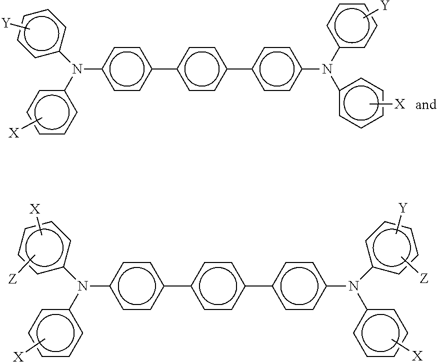

wherein X, Y and Z are independently alkyl, alkoxy, aryl, a halogen, or mixtures thereof, and wherein at least one of Y and Z are present.

Alkyl and alkoxy contain, for example, from 1 to about 25 carbon atoms, and more specifically, from 1 to about 12 carbon atoms, such as methyl, ethyl, propyl, butyl, pentyl, and the corresponding alkoxides. Aryl can contain from 6 to about 36 carbon atoms, such as phenyl, and the like. Halogen includes chloride, bromide, iodide, and fluoride. Substituted alkyls, alkoxys, and aryls can also be selected in embodiments.

Examples of specific aryl amines that can be selected for the charge transport layer include N,N′-diphenyl-N,N′-bis(alkylphenyl)-1,1-biphenyl-4,4′-diamine wherein alkyl is selected from the group consisting of methyl, ethyl, propyl, butyl, hexyl, and the like; N,N′-diphenyl-N,N′-bis(halophenyl)-1,1′-biphenyl-4,4′-diamine wherein the halo substituent is a chloro substituent; N,N′-bis(4-butylphenyl)-N,N′-di-p-tolyl-[p-terphenyl]-4,4″-diamine, N,N′-bis(4-butylphenyl)-N,N′-di-m-tolyl-[p-terphenyl]-4,4″-diamine, N,N′-bis(4-butylphenyl)-N,N′-di-o-tolyl-[p-terphenyl]-4,4″-diamine, N,N′-bis(4-butylphenyl)-N,N′-bis-(4-isopropylphenyl)-[p-terphenyl]-4,4″-diamine, N,N′-bis(4-butylphenyl)-N,N′-bis-(2-ethyl-6-methylphenyl)-[p-terp-henyl]-4,4″-diamine, N,N′-bis(4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4″-diamine, and the like. Other known charge transport layer molecules may be selected in embodiments, reference for example, U.S. Pat. Nos. 4,921,773 and 4,464,450, the disclosures of which are totally incorporated herein by reference.

Examples of the binder materials selected for the charge transport layers include components, such as those described in U.S. Pat. No. 3,121,006, the disclosure of which is totally incorporated herein by reference. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments, the charge transport layer, such as a hole transport layer, may have a thickness of at least about 10 μm, or no more than about 40 μm.

Examples of components or materials optionally incorporated into the charge transport layers or at least one charge transport layer to, for example, enable improved lateral charge migration (LCM) resistance include hindered phenolic antioxidants such as tetrakis methylene(3,5-di-tert-butyl-4-hydroxy hydrocinnamate) methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd.), TINUVIN® 144 and 622LD (available from Ciba Specialties Chemicals), MARK™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl) phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layers is from about 0 to about 20, from about 1 to about 10, or from about 3 to about 8 weight percent.

Examples of the highly insulating and transparent resinous components or inactive binder resinous material for the transport layers include materials such as those described in U.S. Pat. No. 3,121,006, the disclosure of which is totally incorporated herein by reference. Specific examples of suitable organic resinous materials include polycarbonates, such as MAKROLON 5705 from Farbenfabriken Bayer AG or FPC0170 from Mitsubishi Gas Chemical Co., acrylate polymers, vinyl polymers, cellulose polymers, polyesters, polysiloxanes, polyamides, polyurethanes, polystyrenes, polyarylates, polyethers, polysulfones, and epoxies, as well as block, random or alternating copolymers thereof. Specific examples include polycarbonates such as poly(4,4′-isopropylidene-diphenylene)carbonate (also referred to as bisphenol-A-polycarbonate, poly(4,4′-cyclohexylidinediphenylene) carbonate (also referred to as bisphenol-Z polycarbonate), poly(4,4′-isopropylidene-3,3′-dimethyl-diphenyl) carbonate (also referred to as bisphenol-C-polycarbonate), and the like. Specific examples of electrically inactive binder materials include polycarbonate resins having a number average molecular weight of from about 20,000 to about 150,000, from about 40,000 to about 120,000 and from about 50,000 to about 100,000. Any suitable charge transporting polymer can also be used in the charge transporting layer.

The charge transport layer should be an insulator to the extent that the electrostatic charge placed on the hole transport layer is not conducted in the absence of illumination at a rate sufficient to prevent formation and retention of an electrostatic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used.

Drying of the deposited coating may be effected by any suitable conventional technique such as oven drying, infra red radiation drying, air drying and the like. The thickness of the charge transport layer after drying is from about 10 μm to about 40 μm or from about 12 μm to about 36 μm for optimum photoelectrical and mechanical results. In another embodiment the thickness is from about 14 μm to about 36 μm.

In addition, in the present embodiments using a belt configuration, the charge transport layer may consist of a single pass charge transport layer or a dual pass charge transport layer (or dual layer charge transport layer) with the same or different transport molecule ratios. In these embodiments, the dual layer charge transport layer has a total thickness of from about 10 μm to about 40 μm. In other embodiments, each layer of the dual layer charge transport layer may have an individual thickness of from 2 μm to about 20 μm. Moreover, the charge transport layer may be configured such that it is used as a top layer of the photoreceptor to inhibit crystallization at the interface of the charge transport layer and the overcoat layer. In another embodiment, the charge transport layer may be configured such that it is used as a first pass charge transport layer to inhibit microcrystallization occurring at the interface between the first pass and second pass layers.

### The Charge Generation Layer

The charge generation layer 18 may thereafter be applied to the undercoat layer 14. Any suitable charge generation binder including a charge generating/photoconductive material, which may be in the form of particles and dispersed in a film forming binder, such as an inactive resin, may be utilized. Examples of charge generating materials include, for example, inorganic photoconductive materials such as amorphous selenium, trigonal selenium, and selenium alloys selected from the group consisting of selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions may be used where a photoconductive layer enhances or reduces the properties of the charge generation layer. Other suitable charge generating materials known in the art may also be utilized, if desired. The charge generating materials selected should be sensitive to activating radiation having a wavelength between about 400 and about 900 nm during the imagewise radiation exposure step in an electrophotographic imaging process to form an electrostatic latent image. For example, hydroxygallium phthalocyanine absorbs light of a wavelength of from about 370 to about 950 nanometers, as disclosed, for example, in U.S. Pat. No. 5,756,245.

A number of titanyl phthalocyanines, or oxytitanium phthalocyanines for the photoconductors illustrated herein are photogenerating pigments known to absorb near infrared light around 800 nanometers, and may exhibit improved sensitivity compared to other pigments, such as, for example, hydroxygallium phthalocyanine. Generally, titanyl phthalocyanine is known to have five main crystal forms known as Types I, II, III, X, and IV. For example, U.S. Pat. Nos. 5,189,155 and 5,189,156, the disclosures of which are totally incorporated herein by reference, disclose a number of methods for obtaining various polymorphs of titanyl phthalocyanine. Additionally, U.S. Pat. Nos. 5,189,155 and 5,189,156 are directed to processes for obtaining Types I, X, and IV phthalocyanines. U.S. Pat. No. 5,153,094, the disclosure of which is totally incorporated herein by reference, relates to the preparation of titanyl phthalocyanine polymorphs including Types I, II, III, and IV polymorphs. U.S. Pat. No. 5,166,339, the disclosure of which is totally incorporated herein by reference, discloses processes for preparing Types I, IV, and X titanyl phthalocyanine polymorphs, as well as the preparation of two polymorphs designated as Type Z-1 and Type Z-2.

Any suitable inactive resin materials may be employed as a binder in the charge generation layer 18, including those described, for example, in U.S. Pat. No. 3,121,006, the entire disclosure thereof being incorporated herein by reference. Organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

The charge generating material can be present in the resinous binder composition in various amounts. Generally, at least about 5 percent by volume, or no more than about 90 percent by volume of the charge generating material is dispersed in at least about 95 percent by volume, or no more than about 10 percent by volume of the resinous binder, and more specifically at least about 20 percent, or no more than about 60 percent by volume of the charge generating material is dispersed in at least about 80 percent by volume, or no more than about 40 percent by volume of the resinous binder composition.

In specific embodiments, the charge generation layer 18 may have a thickness of at least about 0.1 μm, or no more than about 2 μm, or of at least about 0.2 μm, or no more than about 1 μm. These embodiments may be comprised of chlorogallium phthalocyanine or hydroxygallium phthalocyanine or mixtures thereof. The charge generation layer 18 containing the charge generating material and the resinous binder material generally ranges in thickness of at least about 0.1 μm, or no more than about 5 μm, for example, from about 0.2 μm to about 3 μm when dry. The charge generation layer thickness is generally related to binder content. Higher binder content compositions generally employ thicker layers for charge generation.

### The Overcoat Layer

Other layers of the imaging member may include, for example, an optional overcoat layer 32. An optional overcoat layer 32, if desired, may be disposed over the charge transport layer 20 to provide imaging member surface protection as well as improve resistance to abrasion. In embodiments, the overcoat layer 32 may have a thickness ranging from about 0.1 micrometer to about 10 micrometers or from about 1 micrometer to about 10 micrometers, or in a specific embodiment, about 3 micrometers. These overcoating layers may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene (PTFE), and combinations thereof. Suitable resins include those described above as suitable for photogenerating layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinyichloride copolymers, vinylacetate-vinylidenechloride copolymers, styrene-alkyd resins, polyvinylcarbazoles, and combinations thereof. Overcoating layers may be continuous and have a thickness of at least about 0.5 micrometer, or no more than 10 micrometers, and in further embodiments have a thickness of at least about 2 micrometers, or no more than 6 micrometers.

### The Substrate

The photoreceptor support substrate 10 may be opaque or substantially transparent, and may comprise any suitable organic or inorganic material having the requisite mechanical properties. The entire substrate can comprise the same material as that in the electrically conductive surface, or the electrically conductive surface can be merely a coating on the substrate. Any suitable electrically conductive material can be employed, such as, for example, metal or metal alloy. Electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, niobium, stainless steel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be a single metallic compound or dual layers of different metals and/or oxides.

The substrate 10 can also be formulated entirely of an electrically conductive material, or it can be an insulating material including inorganic or organic polymeric materials, such as MYLAR, a commercially available biaxially oriented polyethylene terephthalate from DuPont, or polyethylene naphthalate available as KALEDEX 2000, with a ground plane layer 12 comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support substrate depends on numerous factors, including mechanical performance and economic considerations.

The substrate 10 may have a number of many different configurations, such as, for example, a plate, a cylinder, a drum, a scroll, an endless flexible belt, and the like. In the case of the substrate being in the form of a belt, as shown in FIG. 9, the belt can be seamed or seamless. In embodiments, the photoreceptor herein is in a drum configuration.

The thickness of the substrate 10 depends on numerous factors, including flexibility, mechanical performance, and economic considerations. The thickness of the support substrate 10 of the present embodiments may be at least about 500 micrometers, or no more than about 3,000 micrometers, or be at least about 750 micrometers, or no more than about 2500 micrometers.

### The Ground Plane

The electrically conductive ground plane 12 may be an electrically conductive metal layer which may be formed, for example, on the substrate 10 by any suitable coating technique, such as a vacuum depositing technique. Metals include aluminum, zirconium, niobium, tantalum, vanadium, hafnium, titanium, nickel, stainless steel, chromium, tungsten, molybdenum, and other conductive substances, and mixtures thereof. The conductive layer may vary in thickness over substantially wide ranges depending on the optical transparency and flexibility desired for the electrophotoconductive member. Accordingly, for a flexible photoresponsive imaging device, the thickness of the conductive layer may be at least about 20 Angstroms, or no more than about 750 Angstroms, or at least about 50 Angstroms, or no more than about 200 Angstroms for an optimum combination of electrical conductivity, flexibility and light transmission.

Regardless of the technique employed to form the metal layer, a thin layer of metal oxide forms on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as a transparent layer for light having a wavelength between about 4000 Angstroms and about 9000 Angstroms or a conductive carbon black dispersed in a polymeric binder as an opaque conductive layer.

### The Hole Blocking Layer

After deposition of the electrically conductive ground plane layer, the hole blocking layer 14 may be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer may be utilized. The hole blocking layer may include polymers such as polyvinylbutryral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl) titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl)methyl diethoxysilane, and [H₂N(CH₂)₃]CH₃Si(OCH₃)₂ (gamma-aminopropyl)methyl diethoxysilane, as disclosed in U.S. Pat. Nos. 4,338,387, 4,286,033 and 4,291,110.

General embodiments of the undercoat layer may comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Undercoat layer binder materials may include, for example, polyesters, MOR-ESTER 49,000 from Morton International Inc., VITEL PE-100, VITEL PE-200, VITEL PE-200D, and VITEL PE-222 from Goodyear Tire and Rubber Co., polyarylates such as ARDEL from AMOCO Production Products, polysulfone from AMOCO Production Products, polyurethanes, and the like.

The hole blocking layer should be continuous and have a thickness of less than about 0.5 micrometers because greater thicknesses may lead to undesirably high residual voltage. A hole blocking layer of between about 0.005 micrometers and about 0.3 micrometers is used because charge neutralization after the exposure step is facilitated and optimum electrical performance is achieved. A thickness of between about 0.03 micrometers and about 0.06 micrometers is used for hole blocking layers for optimum electrical behavior. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer is applied in the form of a dilute solution, with the solvent being removed after deposition of the coating by conventional techniques such as by vacuum, heating and the like. Generally, a weight ratio of hole blocking layer material and solvent of between about 0.05:100 to about 0.5:100 is satisfactory for spray coating.

### The Adhesive Layer

An optional separate adhesive interface layer may be provided in certain configurations, such as for example, in flexible web configurations. In the embodiment illustrated in FIG. 1, the interface layer would be situated between the blocking layer 14 and the charge generation layer 18. The interface layer may include a copolyester resin. Exemplary polyester resins which may be utilized for the interface layer include polyarylatepolyvinylbutyrals, such as ARDEL POLYARYLATE (U-100) commercially available from Toyota Hsutsu Inc., VITEL PE-100, VITEL PE-200, VITEL PE-200D, and VITEL PE-222, all from Bostik, 49,000 polyester from Rohm Hass, polyvinyl butyral, and the like. The adhesive interface layer may be applied directly to the hole blocking layer 14. Thus, the adhesive interface layer in embodiments is in direct contiguous contact with both the underlying hole blocking layer 14 and the overlying charge generator layer 18 to enhance adhesion bonding to provide linkage. In yet other embodiments, the adhesive interface layer is entirely omitted.

Any suitable solvent or solvent mixtures may be employed to form a coating solution of the polyester for the adhesive interface layer. Solvents may include tetrahydrofuran, toluene, monochlorobenzene, methylene chloride, cyclohexanone, and the like, and mixtures thereof. Any other suitable and conventional technique may be used to mix and thereafter apply the adhesive layer coating mixture to the hole blocking layer. Application techniques may include spraying, dip coating, roll coating, wire wound rod coating, and the like. Drying of the deposited wet coating may be effected by any suitable conventional process, such as oven drying, infra red radiation drying, air drying, and the like.

The adhesive interface layer may have a thickness of at least about 0.01 micrometers, or no more than about 900 micrometers after drying. In embodiments, the dried thickness is from about 0.03 micrometers to about 1 micrometer.

### The Ground Strip

The ground strip may comprise a film forming polymer binder and electrically conductive particles. Any suitable electrically conductive particles may be used in the electrically conductive ground strip layer 19. The ground strip 19 may comprise materials which include those enumerated in U.S. Pat. No. 4,664,995. Electrically conductive particles include carbon black, graphite, copper, silver, gold, nickel, tantalum, chromium, zirconium, vanadium, niobium, indium tin oxide and the like. The electrically conductive particles may have any suitable shape. Shapes may include irregular, granular, spherical, elliptical, cubic, flake, filament, and the like. The electrically conductive particles should have a particle size less than the thickness of the electrically conductive ground strip layer to avoid an electrically conductive ground strip layer having an excessively irregular outer surface. An average particle size of less than about 10 micrometers generally avoids excessive protrusion of the electrically conductive particles at the outer surface of the dried ground strip layer and ensures relatively uniform dispersion of the particles throughout the matrix of the dried ground strip layer. The concentration of the conductive particles to be used in the ground strip depends on factors such as the conductivity of the specific conductive particles utilized.

The ground strip layer may have a thickness of at least about 7 micrometers, or no more than about 42 micrometers, or of at least about 14 micrometers, or no more than about 27 micrometers.

### The Anti-Curl Back Coating Layer

The anti-curl back coating 1 may comprise organic polymers or inorganic polymers that are electrically insulating or slightly semi-conductive. The anti-curl back coating provides flatness and/or abrasion resistance.

Anti-curl back coating 1 may be formed at the back side of the substrate 2, opposite to the imaging layers. The anti-curl back coating may comprise a film forming resin binder and an adhesion promoter additive. The resin binder may be the same resins as the resin binders of the charge transport layer discussed above. Examples of film forming resins include polyacrylate, polystyrene, bisphenol polycarbonate, poly(4,4′-isopropylidene diphenyl carbonate), 4,4′-cyclohexylidene diphenyl polycarbonate, and the like. Adhesion promoters used as additives include 49,000 (du Pont), Vitel PE-100, Vitel PE-200, Vitel PE-307 (Goodyear), and the like. Usually from about 1 to about 15 weight percent adhesion promoter is selected for film forming resin addition. The thickness of the anti-curl back coating is at least about 3 micrometers, or no more than about 35 micrometers, or about 14 micrometers.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

### Low-Energy Hydrogen Bombardment

The suitable yield of H₂ projectiles capable of breaking C—H bonds has been found near a H₂ pressure of ˜1 mTorr in 293K for ˜400 eV proton from plasma zone (ECR) entering a drift zone of 50 cm in length. After considering energy loss, the kinetic energy for H₂ projectiles is mainly distributed between about 10 eV and about 20 eV. The yield efficiency of H₂ carrying this range of energy is above 90%. The estimated fluence in this embodiment is about 7×10¹⁶ molecules per cm². The allowable size of photoreceptor flat sheet to be placed in the treatment chamber for hydrogen bombardment is −4 inches×4 inches.

Results:

1. Mechanical Stiffness

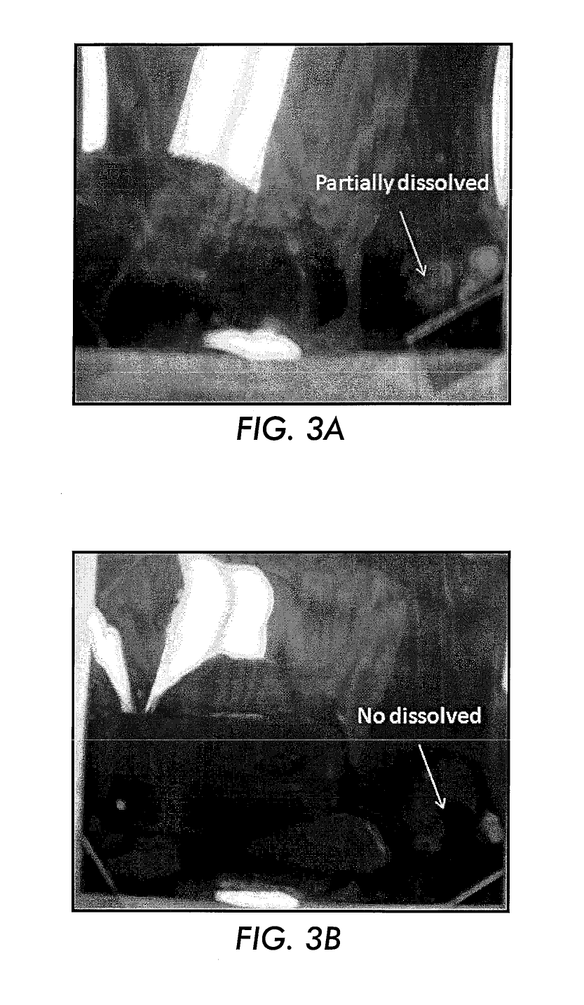

Under designed bombardment parameters, mechanical properties of untreated and treated photoreceptor CTLs have been measured as shown in FIG. 2. The measurements were implemented by Dynamic Mechanical Analyzer Q800 (TA Instruments). The indentation end-load was set at 0.2N, which ensured our indentation experiments only within CTL layer. The indentation speed was 0.2N/min for both of loading and un-loading, and sampling frequency was 0.2 s per sampling point. From the results in FIG. 2, the stiffness of the treated sample surface can be enhanced by up to 10 times of that of pristine sample. We further dip drops of the solvent i.e. hexane on both of untreated and treated sample surfaces. After 15 seconds, the untreated sample partially dissolved in hexane, but the treated sample did not, as shown in FIG. 3. Both tests have proved the cross-linked photoreceptor, as formed by the hydrogen bombardment with our designed parameters. The cross-linked photoreceptor CTL can well sustain a stressful environment with enhanced stiffness and therefore has a reduced wear rate.

2. Electrical Properties

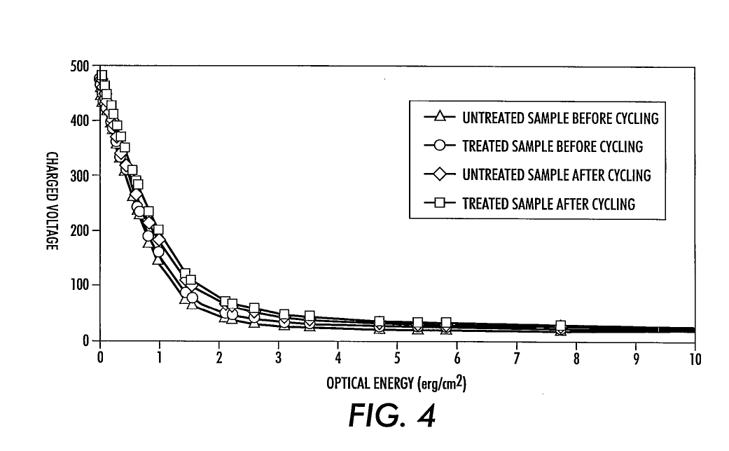

As shown in FIG. 4, the same samples were sent for photo-induced discharge curve (PIDC) and cycling tests on our universal diagnosis scanner. After hydrogen bombardment treatment, the PIDC did not show any difference from that of the pristine sample as regarding sensitivity, residue voltage and dark decade. For example, the residual voltage difference is less than 2V. Cycling tests also did not show any difference on the treated sample regarding the degradation degree of electrical and photo performance in comparison with the pristine sample. For example, the residual voltage difference is less than 5V (e.g., less than 4V, 3V, 2V, 1 v, etc.) after 10000 cycles. Cross-linked photoreceptor by hydrogen bombardment retains the electrical performance of photoreceptor.

3. Printing Tests

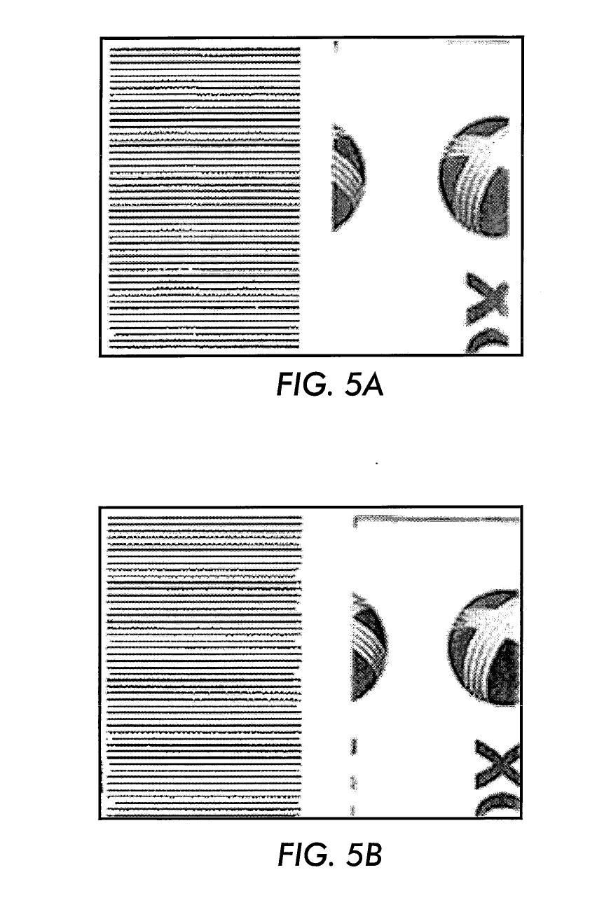

Untreated and treated samples were further sent for black and white printing tests on DocuColor 250 (Xerox Inc.) with Scorotron charging. There was no visible difference between these two samples, as in FIG. 5. They further prove the preserved electrical discharging performance in printing and therefore imaging quality with the treated sample by hydrogen bombardment.

4. Morphological Properties

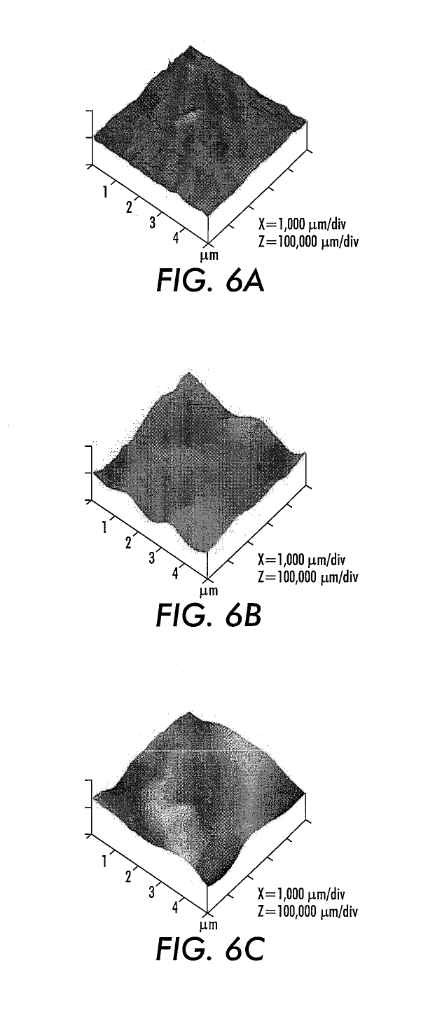

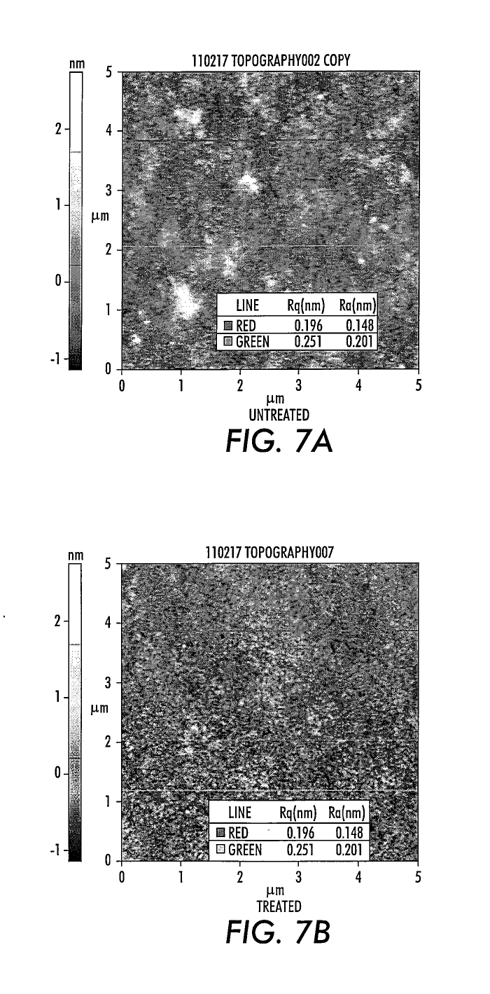

Tapping mode AFM images on morphology of both pristine and treated samples are shown in FIGS. 6 and 7. FIG. 6 shows plasma treated samples and FIG. 7 shows hydrogen bombardment treated samples. The roughness of the untreated and treated samples (by hydrogen bombardment) is the same with Rq=˜0.2 nm. However, from literature reports, plasma treatment method could not finish the same degree of smoothness. Therefore, the proposed treatment method can guarantee the morphological properties of the surface and is beneficial for good contact and possible tribological consideration.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES

WO 2010/099609.
U.S. Publication No. 20030165635.
WO 2012/015075.
Liu Y., et al., “Study of a Hydrogen-bombardment Process for Molecular Cross-linking within Thin Films”, Journal of Chemical Physics, Vol. 134, 074704, 2011.
Solmaz K., et al., “Preparation of antibacterial surfaces by hyperthermal hydrogen induced cross-linking of polymer thin films”, Journal of Materials Chemistry, 22, 4481, 2012.
Qureshi A., et al., “Surface Modification of Polycarbonate by Plasma Treatment”, J. Phys.: Conf. Ser. 208 012108, 2010.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

1. A photoreceptor comprising a surface layer, wherein said surface layer is comprised of an organic composition cured by neutral hydrogen bombardment comprising a molecular hydrogen having kinetic energy of from about 5 eV to about 100 eV and wherein the stiffness of the surface layer is at least 60,000 N/m.

2. (canceled)

3. The photoreceptor of claim 1, wherein the photoreceptor having the cured surface layer displays electrical properties that are at least 90% equivalent to a photoreceptor having a surface layer untreated with neutral hydrogen bombardment, wherein the electrical properties include charge acceptance, dark decay, V_{low} and photosensitivity.

4. (canceled)

5. The photoreceptor of claim 1, wherein the organic composition comprises an organic material containing a hydrogen-carbon bond.

6. The photoreceptor of claim 1, wherein the organic composition contains a photoconductive component.

7. The photoreceptor of claim 1, wherein said organic composition comprises an organic material selected from the group consisting of a charge transport molecule, a polymer, and the mixture thereof.

8. The photoreceptor of claim 7, wherein the charge transport molecule comprises a tertiary arylamine.

9. The photoreceptor of claim 1, wherein said surface layer is part of a charge transport layer comprising a charge transport molecule and a polymer.

10. The photoreceptor of claim 1, wherein the surface layer is an overcoat layer.

11. The photoreceptor of claim 10, wherein the overcoat layer is a separate organic coating disposed on a charge transport layer.

12. The photoreceptor of claim 1, wherein said photoreceptor further comprises a charge generating layer.

13. The photoreceptor of claim 1, wherein the surface layer has a thickness ranging from about 0.1 micron to about 30 microns.

14. A method for forming a photoreceptor having a cured surface comprising
i) providing a photoreceptor member whose surface layer comprises an organic composition containing C—H bond;
ii) providing neutral hydrogen bombardment sources; and
iii) exposing the surface of the photoreceptor to the hydrogen species to form a crosslinked surface through reaction of the C—H bonds in the organic material.

15. The method of claim 14, wherein hydrogen species comprise neutral hydrogen molecules with kinetic energy from about 5 eV to about 100 eV.

16. The method of claim 14, wherein the fluence of hydrogen species is about 3×10¹⁵ to about 1×10¹⁷ molecules per cm².

17. The method of claim 14, wherein said organic composition comprises a material selected from the group consisting of a charge transport molecule, a charge generating material, a polymer, and the mixture thereof.

18. The method of claim 14, wherein the effective depth of hydrogen bombardment is about 1 to about 30 μm.

19. An image forming apparatus comprising:
a multilayered photoreceptor;
a charging unit that electrically charges the surface of the photoreceptor;
an exposing unit that exposes the surface of the photoreceptor electrically charged by the charging unit to form an electrostatic latent image;
a developing unit that develops the electrostatic latent image using a developer containing at least toner to form a toner image; and
a transferring unit that transfers the toner image onto a recording medium,
wherein said multilayered photoreceptor comprises one or more photoconductive layers, wherein at least one photoconductive layer comprises an organic material cured with low-energy neutral hydrogen bombardment from about 5 to about 100 eV and wherein the stiffness of the at least one photoconductive layer is at least 60,000 N/m.

20. The image forming apparatus of claim 19, wherein the photoreceptor possesses a residual voltage increase of less than 5V after 10000 cycles.
